(19) United States
(12) Patent Application Publication
(10) Pub. No.: US 2018/0107228 A1
(43) Pub. Date: Apr. 19, 2018

(54) AUTOPILOT CONTROL SYSTEM

(71) Applicant: Marion S. Williams, Olathe, KS (US)

(72) Inventor: Marion S. Williams, Olathe, KS (US)

(21) Appl. No.: 15/293,052

(22) Filed: Oct. 13, 2016

(51) Int. Cl. G05D 1/08; B64C 17/06; B64D 45/00; G01C 19/42

(52) U.S. Cl. CPC G05D 1/0808; G01C 19/42; B64D 45/00; B64C 17/06

(57) ABSTRACT

Techniques are provided for an autopilot control system to maneuver a vehicle based upon attitude information. The autopilot control system includes an attitude and heading reference module (“AHRM”), a gyroscope confirmation module, a flight control module, and a housing. The AHRM includes a set of AHRM gyroscopes operable to provide an AHRM gyroscopic reading. The gyroscope confirmation module includes a set of confirmation gyroscopes operable to provide a confirmation gyroscopic reading.

### BACKGROUND

Autopilot systems typically utilize an Attitude and Heading Reference System (“AHRS”) to determine and monitor the attitude, heading, acceleration, angular rotation rate, and similar attributes of the vehicle. The AHRS is utilized by an autopilot system to maintain a desired orientation. To error check the AHRS, a duplicate AHRS is often employed to operate independently and simultaneously of the primary AHRS. However, the duplicate AHRS is a significant additional cost, space requirement, and precision alignment requirement.

### SUMMARY

In embodiments of the invention, an autopilot control system comprises an attitude and heading reference module (“AHRM”), a gyroscope confirmation module, a processor, a flight control module, and a housing. The AHRM includes a set of AHRM gyroscopes operable to provide an AHRM gyroscopic reading. The gyroscope confirmation module includes a set of confirmation gyroscopes operable to provide a confirmation gyroscopic reading. The processor is operable to compare the AHRM gyroscopic reading to the confirmation gyroscopic reading to verify that the set of AHRM gyroscopes is providing reasonable rotation rate and attitude information. The housing may contain the AHRM, the gyroscope confirmation module, the processor, and the flight control module therein.

In some embodiments, the set of confirmation gyroscopes and the set of AHRM gyroscopes have the same orientation, such that the results thereof can be directly compared. In some embodiments, the set of confirmation gyroscopes of the gyroscope confirmation module has a lower rate-accuracy (e.g., general quality and accuracy, as discussed below) than the set of AHRM gyroscopes. The lower rate-accuracy allows for significant cost savings while still detecting a hard-over condition. A hard-over condition is a sudden and significant failure of the set of AHRM gyroscopes such that the AHRM gyroscopes are not providing reasonable rotation rate and attitude information. The gyroscope confirmation module detects this hard-over condition. Based upon the finding of the hard-over condition, the autopilot control system may then alert the pilot, disengage from controlling the flight operations of the aircraft, and/or take other corrective actions.

This Summary is provided solely to introduce subject matter that is fully described in the Detailed Description and Drawings. Accordingly, the Summary should not be considered to describe essential features nor be used to determine a scope of the claims.

### BRIEF DESCRIPTION OF THE DRAWINGS

The detailed description is described with reference to the accompanying figures. The use of the same reference numbers in different instances in the description and the figures may indicate similar or identical items.

FIG. 1 is an illustration of an example environment in which techniques may be implemented in an autopilot control system;

FIG. 2 is an illustration of an example method of performing the described techniques;

FIG. 3 is a perspective view of a housing for the autopilot control system;

FIG. 4 is an exploded view of the housing of the autopilot control system illustrating circuit boards therein; and

FIG. 5 is a perspective view of an AHRM circuit board.

### DETAILED DESCRIPTION

### Overview

Some aircraft utilize an autopilot control system to keep the aircraft at a relatively constant attitude, heading, and velocity. A pilot or other person may engage the autopilot control system to control aircraft operations.

It should be appreciated that while the following disclosure refers to aircraft, embodiments of the invention may be utilized with other types of vehicles. In some exemplary embodiments of the invention, the autopilot control system interacts with a boat, a spacecraft, a missile, or other vehicle. It should therefore be noted that throughout the description, “aircraft” could be replaced with “boat,” “spacecraft,” “missile,” “vehicle,” or the like; and “pilot” could be replaced with “sailor,” “captain,” “helmsman,” “astronaut,” or the like. In some embodiments, such as with a missile or unmanned aerial vehicle, no pilot may be present such that the autopilot controls all functions in directing and controlling the vehicle.

The autopilot control system may utilize an inertial guidance system, such as an attitude and heading reference module (“AHRM”) to determine the inertial orientation (attitude, heading, or other characteristics) of the aircraft. The AHRM utilizes sensors to provide information indicative of the orientation of the aircraft. This information can then be utilized by the autopilot control system to change or maintain various aircraft parameters to keep the aircraft on the desired path. The AHRM will typically include a set of magnetometers, a set of accelerometers, and a set of gyroscopes. The set of magnetometers is configured to determine a direction toward the magnetic north pole relative to the aircraft. The set of accelerometers is configured to determine linear and/or angular acceleration of the aircraft. The set of gyroscopes is configured to measure angular changes in orientation of the aircraft. These sensors are discussed in depth below.

In some embodiments of the invention, the autopilot control system is a component of or associated with a flight management system. The flight management system may calculate a desired path for the autopilot control system to follow, based upon a flight plan, positional information, a navigation database, current weather information, and/or other considerations. In other embodiments, the autopilot control system is autonomous. For example, the autopilot control system may keep the current path until disabled without interacting with an external system.

In the following discussion, an example autopilot control system and environment are first described. Exemplary procedures are then described that may be employed with the example environment, as well as with other environments and devices without departing from the spirit and scope thereof. Finally, an exemplary housing for the example autopilot control system is described.

Example Autopilot Control System

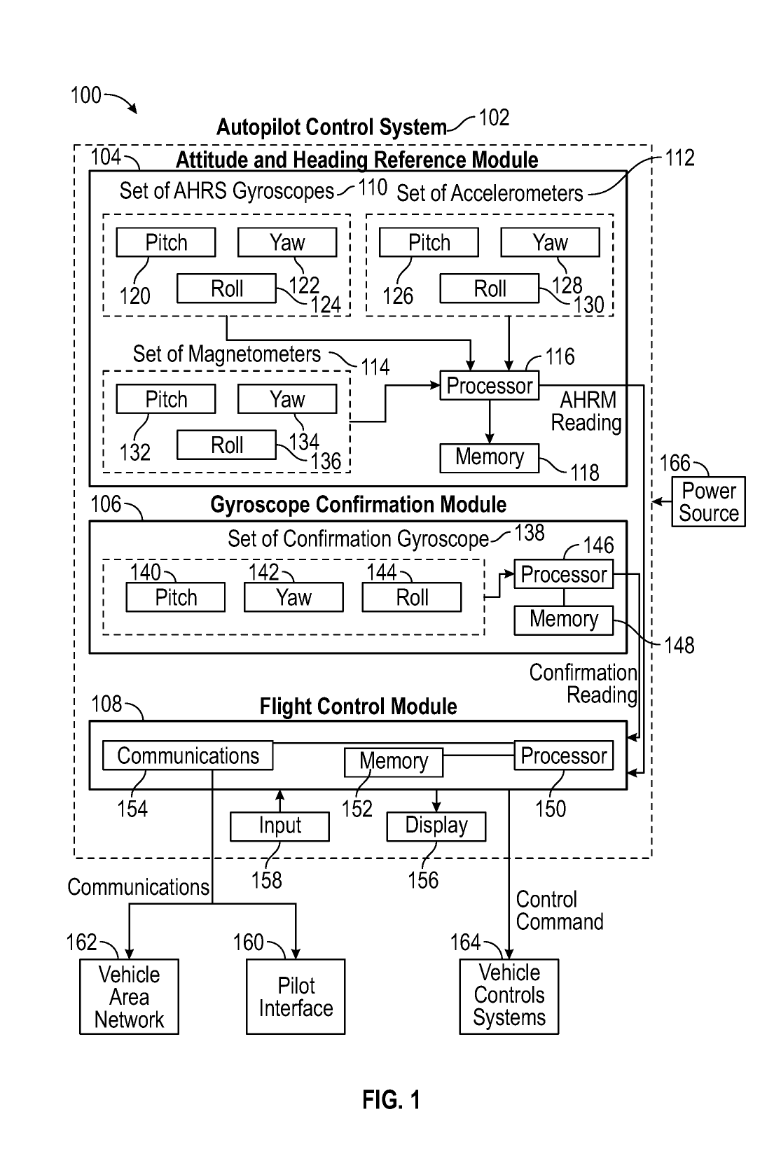

FIG. 1 illustrates an example environment 100 that is operable to perform the techniques discussed herein. The various components are shown schematically for clarity. The environment 100 includes an autopilot control system 102 operable to provide navigation functionality to the aircraft. The autopilot control system 102 may be configured in a variety of ways. For instance, the autopilot control system 102 may directly control operation of the aircraft or may provide instructions or requests that are executed in an external system for controlling the operation of the aircraft. In the following description, a referenced component, such as autopilot control system 102, may refer to one or more entities. Therefore, reference may be made herein to a single entity (e.g., the autopilot control system 102) or multiple entities (e.g., the autopilot control systems 102, the plurality of autopilot control systems 102, etc.) using the same reference number.

An autopilot control system 102 for maneuvering an aircraft based upon attitude information is illustrated in FIG. 1. In embodiments of the invention, the autopilot control system 102 comprises an attitude and heading reference module (“AHRM”) 104, a gyroscope confirmation module 106, and a flight control module 108. Generally, the autopilot control system 102 acquires information about the attitude and heading of the aircraft, compares this information to a desired attitude and heading (based upon a desired path, as discussed below), and instructs the aircraft to change various controls and operations to bring the aircraft to or keep the aircraft at the desired attitude and heading. The heading is the orientation of the aircraft relative to a known location, such as the magnetic north pole of the earth. The attitude is the orientation in space of the aircraft in at least one dimension. The attitude may be relative to a known location such as straight downward (e.g., the direction of the pull of gravity), relative to a hypothetical location such as an artificial horizon, or relative to any other position or orientation helpful for controlling and flying the aircraft. The attitude may also be a measure of the rate of change relative to the known or hypothetical location.

In embodiments of the invention, the autopilot control system 102 includes the AHRM 104. In embodiments of the invention, the AHRM 104 includes a set of AHRM gyroscopes 110, a set of accelerometers 112, and a set of magnetometers 114. In other embodiments of the invention, the AHRM 104 includes the set of AHRM gyroscopes 110 and the set of accelerometers 112, but does not include the set of magnetometers 114. The set of AHRM gyroscopes 110, the set of accelerometers 112, and the set of magnetometers 114 may be collectively referred to as the set of AHRM sensors. In some embodiments of the invention, the AHRM 104 includes a processor 116 and a memory 118. The processor 116 accesses, monitors, or receives information from the set of AHRM sensors, which may be stored in the memory 118 and/or communicated with external modules and systems as discussed below.

The set of AHRM gyroscopes 110 is operable to provide an AHRM gyroscopic reading to the autopilot control system 102. The gyroscopic reading may include a single calculated total reading and/or three independent readings, such as pitch, yaw, and roll. In embodiments of the invention, the set of AHRM gyroscopes 110 includes an AHRM pitch gyroscope 120, an AHRM yaw gyroscope 122, and an AHRM roll gyroscope 124. Each is oriented orthogonally to the others, as discussed below.

In embodiments of the invention, each of the set of AHRM gyroscopes 110 is a rate gyroscope. Rate gyroscopes indicate rates of change of angles as opposed to indicating direction (as with an angle gyroscope). As such the gyroscopic reading is typically indicative of a rate in which the aircraft is angularly moving in space. The AHRM pitch gyroscope 120 therefore provides an indication of a rate of pitch change of the aircraft (e.g., nose up versus nose down). The AHRM yaw gyroscope 122 provides an indication of a rate of yaw change of the aircraft (e.g., nose left versus nose right). The AHRM roll gyroscope 124 provides an indication of a rate of roll change of the aircraft (e.g., right wingtip up versus right wingtip down). In some embodiments, the set of AHRM gyroscopes 110 may be a solid-state (including microelectromechanical systems (“MEMS”)), analog, or laser-ring gyroscope. It should also be appreciated that in other embodiments of the invention, the set of AHRM gyroscopes may include a single gyroscope or two gyroscopes.

The set of accelerometers 112 includes at least one accelerometer configured to measure linear acceleration. In essence, the set of accelerometers 112 measures a direction and magnitude for the pull of gravity on the aircraft (commonly referred to as the “g-force”). In some embodiments of the invention, the set of accelerometers 112 includes a pitch accelerometer 126, a yaw accelerometer 128, and a roll accelerometer 130. The pitch accelerometer 126 measures the force of gravity along a pitch axis (e.g., generally aligned with the wings through the center of gravity of the aircraft, right and left as viewed from the pilot). The yaw accelerometer 128 measures the force of gravity along a yaw axis (e.g., generally vertically through the center of gravity of the aircraft, relative to the static aircraft on the ground, straight up and down as viewed from the pilot). The roll accelerometer 130 measures the force of gravity along a roll axis (e.g., generally horizontally forward through the center of gravity of the aircraft, straight forward and backward as viewed from the pilot). A vector comprising the three readings of the respective accelerometers will therefore point downward, assuming the aircraft is not otherwise accelerating.

The set of accelerometers 112 also measures a magnitude of the acceleration. This provides information regarding acceleration of the aircraft. For example, the aircraft may be accelerating forward due to a force created by the engine, upward due to a lifting force created by the wings, or the like. In some embodiments, these accelerations must be compensated for such that the correct downward direction can be determined. In other embodiments of the invention, the AHRM 104 does not include the set of accelerometers 112. In these embodiments, there may be a set of accelerometers 112 in another component of the aircraft, such as the flight management system discussed above.

The set of magnetometers 114 includes at least one magnetometer operable to measure a magnetic force acting upon the aircraft. The magnetic force provides heading information for the aircraft. The set of magnetometers 114 in essence provides a direction toward the magnetic north pole. This allows the aircraft to know its orientation relative to the earth. For example, this allows the autopilot control system 102 to adhere to the desired path by determining the orientation of the aircraft relative to magnetic north. In some embodiments, the set of magnetometers 114 includes a pitch magnetometer 132, a yaw magnetometer 134, and a roll magnetometer 136. Each magnetometer in the set of magnetometers 114 is aligned with its respective axis, as are the accelerometers 112 as discussed above. In other embodiments of the invention, the set of magnetometers 114 includes the pitch magnetometer 132 and the roll magnetometer 136 (without a yaw magnetometer 134). This is because the aircraft typically remains relatively vertical such that determining magnetic field along the yaw axis (e.g., vertically up and down) is less important. In still other embodiments, the AHRM 104 does not include a set of magnetometers 114. In these embodiments, the AHRM 104 may rely on GPS or other positional information for determining the heading.

It should be noted that in embodiments of the invention the autopilot control system 102 does not include more than three accelerometers and does not include more than three magnetometers. In embodiments of the invention, the autopilot control system 102 lacks dual AHRS and therefore, significantly reduces the cost over conventional systems that include redundant AHRS.

Based upon the set of sensors, the processor 116 of the AHRM 104 outputs an AHRM reading. The AHRM reading is then utilized by the flight control module 108, the flight management system, and/or other aircraft systems. The AHRM reading may be sent continuously, substantially continuously, or periodically. In other embodiments, the processor 116 passively allows other external processors to request, receive, or otherwise acquire the AHRM reading. In embodiments of the invention, the AHRM reading includes an AHRM gyroscopic reading, an AHRM accelerometer reading, and an AHRM magnetometer reading.

The gyroscope confirmation module 106 will now be discussed, as illustrated in FIG. 1. The gyroscope confirmation module 106 provides a confirmation reading obtained from a set of confirmation gyroscopes 138. The set of confirmation gyroscopes 138 is an independent, redundant, and duplicative set of gyroscopes to the set of AHRM gyroscopes 110 (though typically not identical to the set of AHRM gyroscopes 110, as discussed below). The confirmation reading is an independent reading that should typically closely match the AHRM reading of the set of AHRM gyroscopes 110. As discussed below, the AHRM reading will be compared to the confirmation reading to determine if the two respective readings substantially match each other. If the two respective readings do substantially match each other, the autopilot control system 102 will continue maneuvering the aircraft or otherwise utilizing the AHRS data. If the two respective readings do not substantially match each other (e.g., the difference overcomes a certain pre-defined threshold), the autopilot control system 102 will take various corrective or mitigating steps, as discussed below.

In embodiments of the invention, the set of confirmation gyroscopes 138 comprises a pitch confirmation gyroscope 140, a yaw confirmation gyroscope 142, and a roll confirmation gyroscope 144. The gyroscope confirmation module 106 may also include a processor 146 and a memory 148. The processor 146 and the memory 148 are utilized to independently calculate the confirmation reading and communicate with external components, such as the flight control module 108. Independent calculation of the confirmation reading also reduces the likelihood of a common fault with the AHRM reading. In other embodiments of the invention, the set of confirmation gyroscopes 138 includes fewer than three gyroscopes (e.g., one gyroscope or two gyroscopes). Fewer than three gyroscopes may be utilized so as to reduce cost and complexity in the set of confirmation gyroscopes 138. In some instances, fewer than three gyroscopes may be utilized because the vehicle does not have three degrees of freedom (such as in the instance where the set of confirmation gyroscopes 138 are utilized within a water- or land-based vehicle).

The pitch confirmation gyroscope 140 has a first pitch rate-accuracy (e.g., general quality and accuracy, as discussed below) and is operable to provide a pitch change indication. The pitch confirmation gyroscope 140 is disposed so as to measure pitching rotational change (e.g., nose up versus nose down). The yaw confirmation gyroscope 142 has a first yaw rate-accuracy and is operable to provide a yaw change indication. The yaw confirmation gyroscope 142 is disposed to measure yawing rotational change (e.g., nose right versus nose left). The roll confirmation gyroscope 144 has a first roll rate-accuracy and is operable to provide a roll change indication. The roll confirmation gyroscope 144 is disposed to measuring rolling rotational change (e.g., wings tipping in relation to the artificial horizon).

In embodiments of the invention, each of the set of confirmation gyroscopes 138 is a rate gyroscope, like the set of AHRM gyroscopes 110. As such the gyroscopic reading is typically indicative of a rate in which the aircraft is angularly moving in space. In some embodiments, the set of confirmation gyroscopes 138 may be a solid-state (including MEMS), analog, or laser-ring gyroscope.

To provide reliable confirmation information, the set of AHRM gyroscopes 110 is typically aligned with the set of confirmation gyroscopes 138. “Aligned” as used herein means that the respective gyroscopes are oriented in substantially the same axis. Aligned gyroscopes may be parallel, co-linear, or may be offset at a known angle (such that the known angle may be compensated for by calculation). As opposed to conventional systems, in which the duplicate AHRS is in a separate housing from the primary AHRS, the autopilot control system 102 of embodiments of the invention has the set of AHRM gyroscopes 110 aligned with the set of confirmation gyroscopes 138 by keeping both respective sets in the same housing (as discussed below). This reduces the installation burden, in which both AHRS are installed such that they are substantially aligned, in the same orientation, and near one another. Embodiments of the invention overcome these issues by placing the set of confirmation gyroscopes 138 within the same housing as the set of AHRM gyroscopes 110 so as to ensure that the set of confirmation gyroscopes 138 remains aligned with the set of AHRM gyroscopes 110.

The pitch confirmation gyroscope 140 is disposed in a first orientation. The yaw confirmation gyroscope 142 is disposed in a second orientation. The roll confirmation gyroscope 144 is disposed in a third orientation. The first orientation is orthogonal to both the second orientation and the third orientation. As such the first orientation could be assigned to an x-axis, the second orientation could be assigned to a y-axis, and the third orientation could be assigned to a z-axis. It should be appreciated that the respective assigned axis for each gyroscope 140,142,144 could also be different.

In embodiments of the invention, the AHRM pitch gyroscope 120 is disposed in the same first orientation as the pitch confirmation gyroscope 140, the AHRM yaw gyroscope 122 is disposed in the same second orientation as the yaw confirmation gyroscope 142, and the AHRM roll gyroscope 124 is disposed in the same third orientation as the roll confirmation gyroscope 144. Because the set of AHRM gyroscopes 110 is aligned with and near to the set of confirmation gyroscopes 138, the AHRM reading should be substantially similar to the confirmation reading (assuming that all the gyroscopes are working properly). If there is a discernable difference between the respective readings, this is an indication that at least one gyroscope (of either the set of AHRM gyroscopes 110 or the set of confirmation gyroscopes 138) is failing or otherwise providing erroneous readings. In this situation, the autopilot control system may take the mitigating steps discussed below even if the autopilot control system cannot determine whether the at least one gyroscope that is failing is in the set of confirmation gyroscopes 138 or in the set of AHRM gyroscopes 110. However, in some configurations, the gyroscopes 110, 138 need not be physically aligned and/or oriented with respect to each other. Instead, another plane of reference may be utilized, such as the Earth or an aircraft/vehicle body, where gyro rates are mathematically transformed for comparison. Such a computation could be useful, for example, in situations where flight control software already has the gyro rates referenced to the aircraft body or the Earth.

The rate-accuracy of the various gyroscopes operate will now be discussed. As used herein, “rate-accuracy” is a general measure of the quality of the gyroscope. The quality of gyroscopes may be defined based on any or all of several parameters. For one example, the rate-accuracy may include a scale factor accuracy, bias accuracy, and other deterministic error accuracies. As a second example, rate-accuracy may include a rate range, such as a maximum measurement rate in degrees per second. As a third example, the rate accuracy may include a temperature stability rating, such as a change in rotation rate when exposed to temperature extremes and/or temperature variation. As a fourth example, rate-accuracy may include a vibration immunity rating, such as a change in rotation rate when exposed to vibration amplitudes, gravitational force peaks, and other frequencies. As a fifth example, rate-accuracy may include a random noise rating, such as degrees per second per square root of hertz.

In embodiments of the invention, the set of confirmation gyroscopes 138 operates at a first rate-accuracy and the set of AHRM gyroscopes 110 operates at a second rate-accuracy. The second rate-accuracy is substantially greater than the first rate-accuracy. This difference in the rate-accuracies may be referred to as a rate-accuracy differential. The rate-accuracy differential is a measure in the difference in rate-accuracy and other qualities of the respective sets of gyroscopes 110,138. Because the set of AHRM gyroscopes 110 is utilized to maneuver the aircraft during autopilot operations and provide information about the aircraft during all flight operations, the set of AHRM gyroscopes 110 is of a high rate-accuracy. This is because precise visual display of the aircraft orientation is required during all flight maneuvers, including during abrupt motions where the pilot is manually flying the aircraft, or where turbulent weather is present.

However, the autopilot control system 102 typically only controls aircraft maneuvering when autopilot functionality is engaged. The autopilot controls the aircraft using slower and gentler motions that optimize passenger comfort. In this way, the set of confirmation gyroscopes 138 can be of a lower rate-accuracy (e.g., a lower quality and accuracy). The set of confirmation gyroscopes 138 may only confirm the AHRM reading while autopilot functionality is being utilized. The lower rate-accuracy of the confirmation gyroscopes 138 provides a significant cost savings while still providing confirmation of the AHRM reading while the autopilot functionality is engaged.

In embodiments of the invention, the first pitch rate-accuracy (of the pitch confirmation gyroscope 140), the first yaw rate-accuracy (of the yaw confirmation gyroscope 142), and the first roll rate-accuracy (of the roll confirmation gyroscope 144) are substantially equal. Similarly, the second pitch rate-accuracy (of the AHRM pitch gyroscope 120), the second yaw rate-accuracy (of the AHRM yaw gyroscope 122), and the second roll rate-accuracy (of the AHRM roll gyroscope 124) are substantially equal.

The flight control module 108 will now be discussed. In embodiments of the invention, the fight control module includes a processor 150, a memory 152, and a communications element 154. In some embodiments, the flight control module 108 interacts with or is associated with a display 156 and an input 158. The flight control module 108 is typically housed with the AHRM 104 and/or the gyroscope confirmation module 106, as discussed below.

In embodiments of the invention, the flight control module 108 controls, instructs, and/or requests the maneuvering of the aircraft. The flight control module 108 is typically engaged by the pilot or other person so as to allow the pilot or other person to perform other tasks without hands-on maneuvering of the aircraft. The pilot may instruct the flight control module 108 to hold the current attitude and heading, to adhere to a desired path provided by the flight management system, or to perform a certain maneuver such as ascend to a designated altitude, fly an approach, or the like.

In embodiments of the invention, the flight control module 108 is configured to control maneuvering of the aircraft in all three degrees of movement (pitch, yaw, and roll). In some embodiments, the flight control module 108 is also configured to control the thrust produced by the engine so as to allow for acceleration and deceleration (autothrottle). In other embodiments, the flight control module 108 is configured to control maneuvering the aircraft in only one degree of movement (such as a “wing leveler” autopilot that only controls the roll of the aircraft) or two degrees of movement (such as a “nose leveler” autopilot that only controls the pitch and roll of the aircraft).

The processor 150 of the flight control module 108 receives or otherwise acquires the AHRM reading and the confirmation reading. In some embodiments, the processor 150 actively pulls the readings from the respective processors 116,146 or sensors 110,112,114,138. In other embodiments, the processor 150 passively receives the information from the respective processors 116,146 or sensors 110,112,114,138. The processor 150 is operable to compare the AHRM gyroscopic reading to the confirmation gyroscopic reading to verify that the AHRM gyroscopes 110 are providing attitude information. The processor 150 is also operable to detect a hard-over condition upon identifying a reading differential between the AHRM gyroscopes 110 and the confirmation gyroscopes 138 being outside a pre-set threshold.

A hard-over condition is a sudden and large failure of at least one of the set of AHRM gyroscopes 110. The hard-over condition is detected by comparing the AHRM reading to the confirmation reading. This is because simultaneous and analogous failure of the AHRM 104 and the gyroscope confirmation module 106 is unlikely. Unlike conventional systems, in which two identical AHRS are used, a common fault is also unlikely because the gyroscope confirmation module 106 utilizes different gyroscopes to independently determine the confirmation reading.

In some embodiments, the flight control module 108 detects a hard-over condition based upon exceeding a pre-defined threshold in the comparison of the pitch change indication, the comparison of the yaw change indication, and the comparison of the roll change indication. In other embodiments, the flight control module 108 detects the hard-over condition based upon the total AHRM reading and the total confirmation reading. The detection of the hard-over condition is discussed in more detail below.

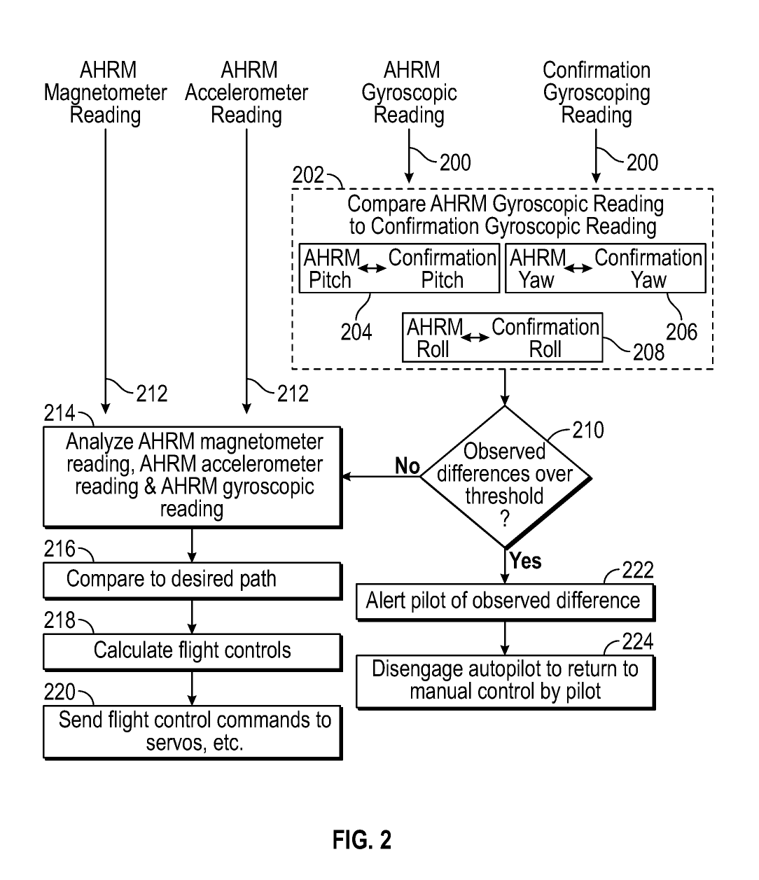

It should also be appreciated that in other embodiments of the invention, the hard-over condition is detected by the AHRM 104. In these embodiments, the gyroscope confirmation module 106 sends the confirmation reading to the AHRM 104. The AHRM 104 utilizes this information to ensure that the AHRM reading is providing verified attitude information (as discussed below with respect to Step 210 of FIG. 2) before sending the AHRM reading to the flight control module 108. In still other embodiments, the hard-over condition is detected by the gyroscope confirmation module 106. In these embodiments, the processor 146 of the gyroscope confirmation module 106 is monitoring the AHRM reading. Upon detecting the hard-over condition, the processor 146 of the gyroscope confirmation module 106 may then send a message to the flight control module 108 indicative of the hard-over condition, such that the flight control module 108 may take the mitigating steps discussed below or other actions.

In FIG. 1, the autopilot control system 102 is illustrated as including three processors 116,146,150. Each processor 116,146,150 provides processing functionality for the autopilot control system 102 and may include any number of processors, micro-controllers, or other processing systems, and resident or external memory for storing data and other information accessed or generated by the autopilot control system 102. The processor 116,146,150 may execute one or more software programs that implement the techniques and modules described herein. The processor 116,146,150 is not limited by the materials from which it is formed or the processing mechanisms employed therein and, as such, may be implemented via semiconductor(s) and/or transistors (e.g., electronic integrated circuits (ICs)), and so forth. It should also be appreciated that the discussed functions and methods performed by one of the processors 116,146,150 may be performed by any of the other processors 116,146,150.

It should be appreciated that FIG. 1 illustrates only one exemplary embodiment of the invention. In other embodiments, there is only a single processor in the autopilot control system 102. The single processor receives the information from the set of AHRM sensors and the set of confirmation gyroscopes and calculates the maneuver instructions to send to the servos and other aircraft systems. FIG. 1 illustrates three separate processors 116,146,150 for demonstrative reasons. More or fewer processors could also be utilized in the autopilot control system 102.

Three memory elements 118,148,152 are illustrated in FIG. 1. The memory element 118,148,152 is an example of device-readable storage media that provides storage functionality to store various data associated with the operation of the autopilot control system 102, such as the software program and code segments mentioned above, or other data to instruct the processor 118,146,150 and other elements of the autopilot control system 102 to perform the techniques described herein. A wide variety of types and combinations of memory may be employed. The memory 118,148,152 may be integral with the processor 116,146,150, a stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth. In embodiments of the autopilot control system 102, the memory may include removable ICC (Integrated Circuit Card) memory such as provided by SIM (Subscriber Identity Module) cards, USIM (Universal Subscriber Identity Module) cards, UICC (Universal Integrated Circuit Cards), and so on. In other embodiments, there is only a single memory element in the autopilot control system 102. FIG. 1 illustrates three separate memory elements 118,148,152, but more or fewer memory elements could also be utilized in the autopilot control system 102.

The autopilot control system 102 may also include a communications element 154 representative of communication functionality to permit autopilot control system 102 to send/receive data between different devices (e.g., components/peripherals) and/or over the one or more networks. The communications element 154 includes one or more Network Interface Units. NIU may be any form of wired or wireless network transceiver known in the art, including but not limited to networks configured for communications according to the following: one or more standards of Aeronautical Radio, Incorporated (ARINC); one or more standards of the Garmin International avionics network (GIA); and the like. Wired communications are also contemplated such as through universal serial bus (USB), Ethernet, serial connections, and so forth. Autopilot control system 102 may include multiple NIUs for connecting to different networks or a single NIU that can connect to each necessary network.

The communications element 154 may also have a wired and/or wireless connection to a pilot interface 160 and/or a vehicle-area network (VAN) 162 for the aircraft in which it is used. The pilot interface 160 may include a primary flight display or a multifunction display. The pilot interface 160 may display information received from the autopilot control system 102 for the pilot. Where such a vehicle-area network includes vehicle subsystem data such as the servos, the engine control unit, pilot interfaces 160, radios/satellites and other external communication devices, and vehicle (i.e., aircraft) controls, it may also be referred to as a Controller Area Network (CAN). VAN 162 may include one or more integrated displays and/or speakers for the pilot. When this is the case, autopilot control system 102 may not include its own display 156 but instead use the aircraft's integrated display, or both. Alternatively, VAN 162 may not integrate into the aircraft itself, but rather connect peripherals and other devices installed in or used in the aircraft. The VAN 162 may also integrate with the vehicle control systems 164 (i.e., aircraft control systems) such that the communications element 154 can send control commands that will maneuver the aircraft. The sending of control commands is discussed in more depth below.

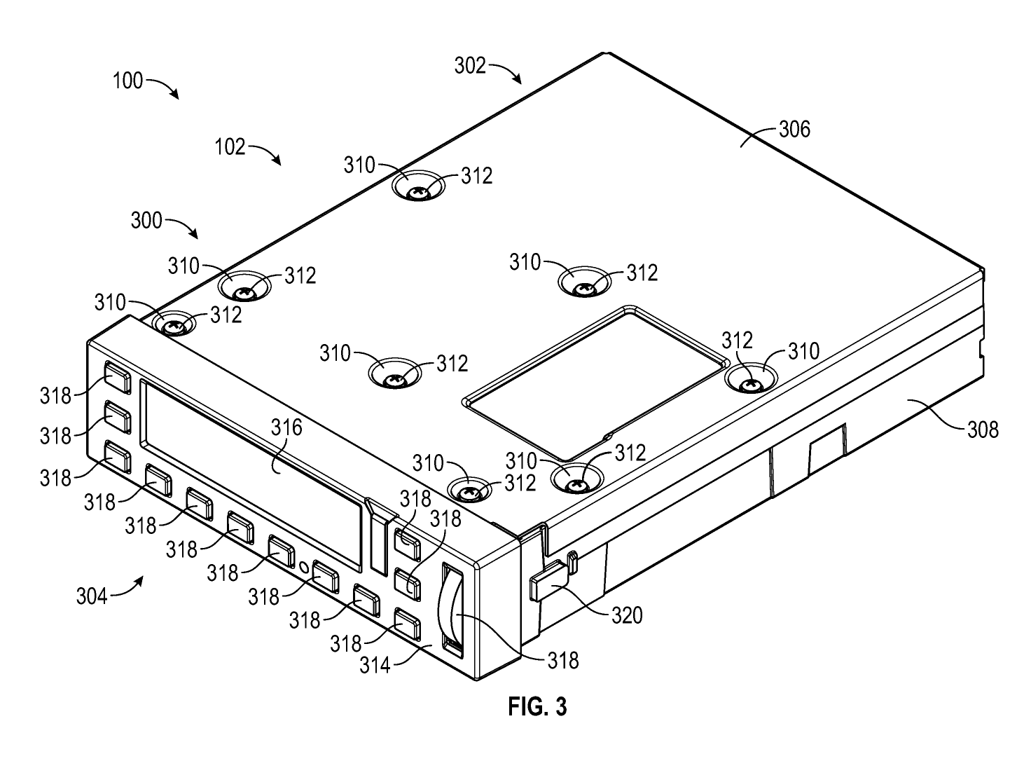

In embodiments of the invention, the autopilot control system 102 includes the display 156 to present information to a user of the autopilot control system 102, as illustrated in FIG. 3 and discussed below. In embodiments, the display 156 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display 156 may be backlit via a backlight such that it may be viewed in the dark or other low-light environments.

The input 158 of the autopilot control system 102 may include buttons, dials, and other input structures (as illustrated in FIG. 3 and discussed below). The input 158 allows the pilot or other person to set up the autopilot control system 102, provide commands to the autopilot control system 102, check the status of the autopilot control system 102, and perform other functions as may be necessary. In embodiments, the screen of the display 156 comprises a touch screen. For example, the touch screen may be a resistive touch screen, a surface acoustic wave touch screen, a capacitive touch screen, an infrared touch screen, optical imaging touch screens, dispersive signal touch screens, acoustic pulse recognition touch screens, combinations thereof, and the like.

In embodiments of the invention, the autopilot control system 102 also includes power source 166. In some embodiments, power source 166 is a source independent of the aircraft, such as batteries. In other embodiments, power source 166 is an external power adapter receiving power from a vehicular power source providing AC or DC power and, if necessary, transforming it appropriately for use by autopilot control system 102. As a non-limiting example, power source 166 in such embodiments is a cable coupled with the navigation autopilot control system 102 and the vehicular power source to provide power to the device. In some such embodiments, this power is independent of environment 100. In other embodiments, it is affected by environment 100. For example, when autopilot control system 102 is mounted in the aircraft, power source 166 may provide power only when the aircraft is operating or otherwise powered on.

Example Procedures

The following discussion describes procedures that can be implemented in an autopilot control system 102. The procedures can be implemented as operational flows in hardware, firmware, software, or a combination thereof. These operational flows are shown below as a set of blocks that specify operations performed by one or more devices and are not necessarily limited to the orders shown for performing the operations by the respective blocks. The features of the operational flows described below are platform-independent, meaning that the operations can be implemented on a variety of device platforms having a variety of processors.

FIG. 2 presents a flowchart illustrating the operation of a method of maneuvering the aircraft while the AHRM 104 is providing attitude information using embodiments of the invention. In particular, FIG. 2 illustrates the steps of verifying that a gyroscope reading of the gyroscope confirmation module (the “confirmation gyroscopic reading”) is within a pre-defined tolerance or threshold of a gyroscope reading of the AHRM gyroscopes (the “AHRM gyroscopic reading”).

In Step 200, the AHRM gyroscopic reading and the confirmation gyroscopic reading are received, retrieved, or otherwise acquired. The AHRM gyroscopic reading and/or the confirmation gyroscopic reading may be acquired by accessing the AHRM processor 116 and the confirmation processor 146, respectively. The AHRM gyroscopic reading and the confirmation gyroscopic reading is each calculated based upon the set of AHRM gyroscopes 110 and the set of confirmation gyroscopes 138, respectively.

In Step 202, the processor 150 compares the AHRM gyroscopic reading to the confirmation gyroscopic reading. In some embodiments, this may include comparing the individual components of the respective gyroscopic readings. In Step 204, the AHRM pitch reading is compared to the confirmation pitch reading. In Step 206, the AHRM yaw reading is compared to the confirmation pitch reading. In Step 208, the AHRM roll reading is compared to the roll confirmation reading. In these embodiments, the respective readings are compared against each other. In this way, individual discrepancies are more easily detected. In some embodiments, the readings may include a timestamp or other metadata to assist in synchronizing the readings. In other embodiments, the current AHRM gyroscopic reading and the current confirmation gyroscopic reading are compared in real time, or substantially real time.

The difference between any two respective readings is known as the reading differential. The reading differential is a measure of the magnitude of the difference between the two respective gyroscopic readings at any given time. The reading differential will therefore be constantly changing as the two respective gyroscopic readings change relative to one another. As an example, there may be an overall reading differential, a pitch reading differential, a yaw reading differential, and a roll reading differential. Any or all of these examples may be referred to as the “reading differential” herein.

In Step 210, the processor 150 determines whether the reading differential (e.g., the observed difference between the AHRM gyroscopic reading and the confirmation gyroscopic reading) is over a certain pre-defined threshold. Alternatively stated, a determination is made whether the reading differential is within a pre-defined tolerance. In some embodiments of the invention, being over the pre-defined threshold includes the reading differential being over the pre-defined threshold for a certain period of time. This prevents the autopilot from disengaging over minor, transient errors in the data.

As an example, the pre-defined threshold for angular rate differences may be substantially half of a degree per second, one degree per second, two degrees per second, or three degrees per second. As another example, the pre-defined threshold may fall into a range between one and two degrees per second, between one and three degrees per second, more than three degrees per second, or another range. As discussed above, the pre-defined threshold may also include an elapsed time threshold. As an example, the reading differential may have to be over the pre-defined threshold for at least one tenth of a second, at least half of a second, at least one second, at least two seconds, or at least three seconds.

In Step 212, if the reading differential is not over the pre-defined threshold, the processor 150 then receives, accesses, or otherwise acquires the AHRM magnetometer reading and/or the AHRM accelerometer reading. It should be appreciated that if the reading differential is within the pre-defined threshold, i.e., the confirmation gyroscopic reading is within the pre-defined threshold of the AHRM gyroscopic reading, then operation of the AHRM gyroscopes is verified. As such, the AHRM gyroscopes are providing verified attitude information. In contrast, if the AHRM gyroscopic reading is outside of the pre-defined threshold, then this is indicative of a potential fault in the operation of the AHRM gyroscopes. As discussed above, in embodiments of the invention, the AHRM 104 includes at least one accelerometer and at least one magnetometer. Based upon the determination that the set of AHRM gyroscopes 110 is providing verified attitude information, the processor 150 will proceed with performing the autopilot functions. It should also be appreciated that, like the other steps discussed herein, Step 212 may be performed simultaneously with Step 200. As such, all readings are received simultaneously and the comparison discussed in Step 202 is performed subsequently.

In Step 214, the processor 150 analyzes the AHRM magnetometer reading, the AHRM accelerometer reading, and the AHRM gyroscopic reading. The AHRM magnetometer reading is indicative of the orientation of the aircraft relative to magnetic north. The AHRM accelerometer reading is indicative of the direction of the force of gravity, plus inertial forces due to turns, climbs, and descents, so as to show the orientation of the aircraft relative to the ground. The AHRM gyroscopic reading is indicative of the rates of change of orientation. Based upon this analysis, the processor 150 determines the current attitude and heading of the aircraft. The processor 150 may also analyze thrust information from the engines and other aircraft systems in determining the current attitude and heading.

It should be noted that in embodiments of the invention, the confirmation gyroscopic reading is not utilized in determining the actual aircraft attitude. Instead the AHRM gyroscopic reading is used to determine the actual attitude of the aircraft. This is because the set of confirmation gyroscopes 138 may be of a lower rate-accuracy than the set of AHRM gyroscopes 110. As such the set of confirmation gyroscopes 138 may have a reduced precision or range of available readings (for example, the set of confirmation gyroscopes 138 may be limited to 30 degrees per second while the set of AHRM gyroscopes 110 may be limited to 200 degrees per second). In other embodiments, both the AHRM gyroscopic reading and the confirmation gyroscopic reading are analyzed in determining the rate of change of the orientation.

In Step 216, the processor 150 compares the current attitude and heading of the aircraft against a desired path, which may be static or variable. Based upon the comparison of the desired path to the AHRM magnetometer reading, the AHRM accelerometer reading, and the AHRM gyroscopic reading, in Step 218 the processor 150 calculates flight controls necessary to bring the aircraft to the desired path. It should be appreciated that typically the flight controls utilized by the autopilot control system 102 will gradually and gently bring the aircraft to the desired path. The autopilot control system 102 may calculate a corrective path to bring the aircraft to the desired path. The autopilot control may then calculate the flight controls to bring the aircraft to the corrective path and then to leave the corrective path, and move onto the desired path.

In some instances, the calculated flight controls can include changes to the ailerons, changes to the elevators, changes to the rudder, changes to the flaps, changes to the thrust, or some combination thereof. The calculated flight controls may also include a duration of the changes, an initiation time for the changes, a termination time for the changes, or the like.

In Step 220, the processor 150 sends the flight control commands to the servos or other aircraft systems. Servos are associated with various aircraft flight control surfaces. For example, there may be servos associated with the ailerons, servos associated with the elevators, servos associated with the rudder, servos associated with the flaps, servos associated with the spoilers, servos associated with trimming surfaces, etc. The processor 150 may send the commands via the communications element 154 or directly to the servos.

If, in Step 210 discussed above, the reading differential is above the pre-defined threshold, the autopilot control system 102 may take mitigating steps. In Step 222, the processor 150 may issue or instruct an alert to the pilot of the detected hard-over condition. The alert may include audible alarms, audible voices, visual alarms, visible words, or the like. The alert ensures that the pilot is aware that the hard-over condition has been detected. This gives the pilot an opportunity to stop performing other secondary functions and/or return to hands-on flight of the aircraft.

In Step 224, the autopilot control system 102 automatically disengages autopilot functionality to return manual control to the pilot. In other embodiments, the pilot is alerted to the observed difference, as set forth in Step 222, but the autopilot functionality is not automatically disengaged, and instead, the pilot is asked whether the autopilot functionality should be disengaged. In some embodiments, the processor 150 may allow the autopilot control system 102 to again perform autopilot functions upon the reading differential falling back below the pre-defined threshold. In other embodiments, the processor 150 will not allow the autopilot control system 102 to restart the autopilot functions for the remainder of the flight.

Generally, any of the functions described herein may be implemented using software, firmware, hardware (e.g., fixed logic circuitry), manual processing, or a combination of these implementations. The terms “module” and “functionality” as used herein generally represent software, firmware, hardware, or a combination thereof. The communication between modules in the autopilot control system 102 of FIG. 1 may be wired, wireless, or some combination thereof. In the case of a software implementation, for instance, the module represents executable instructions that perform specified tasks when executed on a processor 150, such as the processor 150 of the flight control module 108 associated with the autopilot control system 102 of FIG. 1. The program code may be stored in one or more device-readable storage media, an example of which is the memory 152 of the flight control module 108 associated with the autopilot control system 102 of FIG. 1.

Example Housing for the Autopilot Control System

A housing 300 of the autopilot control system 102 will now be discussed. An exemplary embodiment of the housing 300 is illustrated in FIGS. 3-5. In some embodiments of the invention, the housing 300 secures the AHRM 104, the gyroscope confirmation module 106, and the flight control module 108 therein. In other embodiments of the invention, the housing 300 secures the gyroscope confirmation module 106 and the flight control module 108 therein, and the AHRM 104 is housed separately. In still other embodiments, the housing 300 secures the AHRM 104 and the gyroscope confirmation therein, and the flight control module 108 is housed separately.

In embodiments of the invention, the housing 300 generally comprises a body 302 and a face 304 and presents a generally rectangular prism shape. The body 302 secures various circuit boards, sensors, and other components therein (as discussed below). The face 304 invites the user to input information and displays information to the user. Typically, the housing 300 will be installed into the aircraft such that the body 302 is concealed and the face is visible. In some embodiments of the invention, the face is formed of a polymer such as plastic and the body 302 is formed of metal.

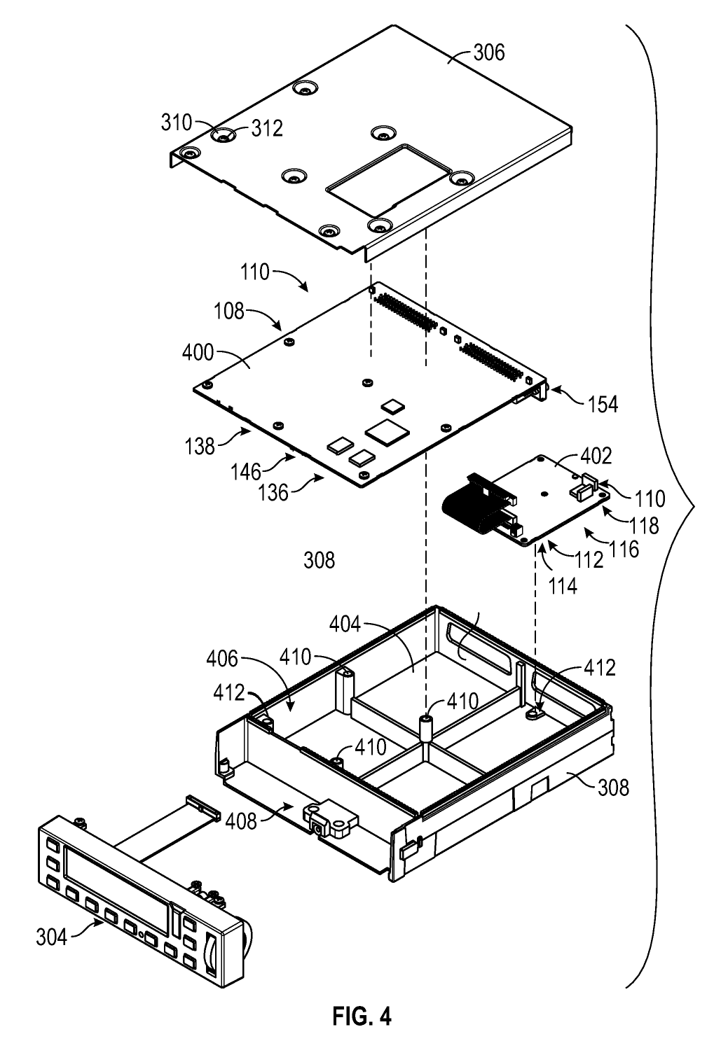

In embodiments of the invention, the body 302 comprises a top plate 306 and at least one sidewall 308. The top plate 306 may also present at least one fastener opening 310 for the receipt of fasteners 312 therein. The fasteners 312 secure the top plate 306 against the sidewalls 308 and secure the internal components (as shown in FIG. 4) therein.

In embodiments of the invention, the face 304 comprises a face plate 314, a display 316, at least one input 318, and at least one alignment key 320. The face plate 314 encloses a pilot-facing side of the housing 300 and secures the display 316 and the inputs 318. The display 316 shows current information about the autopilot control system 102, such as a status, the alert discussed above, the desired path, the current path, the flight commands being issued, the observed reading differential, the duration of autopilot functionality, and other information related to the autopilot control system 102. The display 316 may also display information related to the inputs 318 being selected by the pilot or other person. The inputs 318 may include buttons, dials, and the like. In some embodiments, the input 318 may include the display 316, being a touchscreen as discussed above. The alignment key 320 is configured to interface with a bracket or other installation location of the aircraft, so as to emplace and keep the autopilot control system 100 in the aircraft.

Turning to FIG. 4, an exploded view of the exemplary autopilot control system 102 is illustrated. In embodiments of the invention, the autopilot control system 102 comprises a confirmation-controller circuit board 400 and an AHRM circuit board 402. In these embodiments, the gyroscope confirmation module 106 and the flight control module 108 are each associated with confirmation-controller circuit board 400. The set of AHRM gyroscopes 110, the set of accelerometers 112, and the set of magnetometers 114 are disposed on the AHRM circuit board 402. The set of confirmation gyroscopes 138 is disposed on the confirmation-controller circuit board 400. In embodiments of the invention, both the AHRM circuit board 402 and the confirmation-controller circuit board 400 are integrated circuit boards.

The AHRM circuit board 402 is disposed relative to the gyroscope confirmation-controller circuit board 400 such that the set of AHRM gyroscopes 110 and the set of confirmation gyroscopes 138 are oriented in a same direction within the housing 300. In this way precisely aligning two duplicate AHRS is avoided. Instead, in embodiments of the invention both the set of AHRM gyroscopes 110 and the set of confirmation gyroscopes 138 are within the same housing 300 such that the relative orientations of the gyroscopes are known and constant. In other embodiments, the autopilot control system 102 comprises an AHRM circuit board, a controller circuit board, and a confirmation-controller circuit board 400. In still other embodiments, the various components of the autopilot control system 102 are disposed on a single circuit board.

As illustrated in FIG. 4, the housing 300 may further include a floor 404 so as to present a component void 406 and a face void 408. The component void 406 is configured to receive circuit boards and other components therein. The face void 408 is configured to receive the face 304 and associated components therein. The floor 404 may also present at least one fastener receptor 410 for securing the fasteners 312 thereto and at least one board support 412 for securing at least one circuit board thereto. The housing 300 therefore securely holds at least one circuit board therein so as to ensure that the set of AHRM gyroscopes 110 and the set of confirmation gyroscopes 138 are aligned, as discussed above.

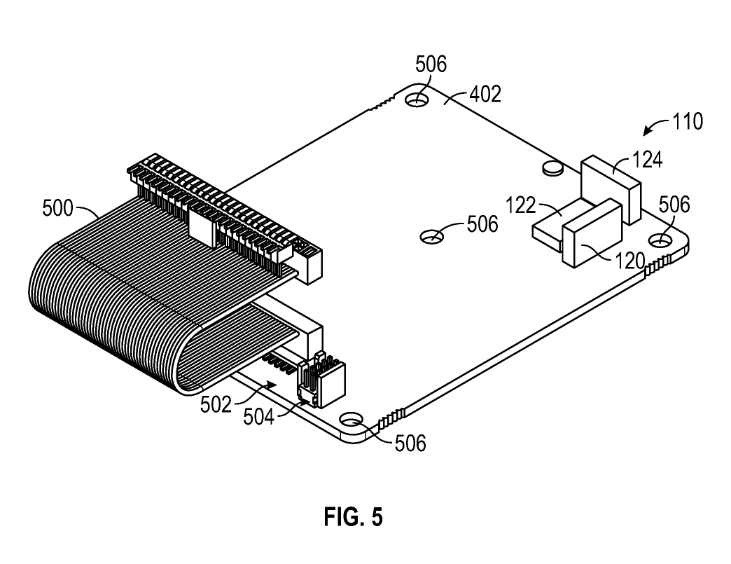

Turning to FIG. 5, a more detailed view of the ARHM circuit board 402 is illustrated. The set of AHRM gyroscopes 110, including the pitch AHRM gyroscope 120, the yaw AHRM gyroscope 122, and the roll AHRM gyroscope 124, is disposed thereon. A communications cable 500 is also illustrated for the transfer of information between the confirmation-controller circuit board 400 and the AHRM circuit board 402. The AHRM circuit board 402 may also comprise a communications port 502 and a power port 504 for the receipt of the communications cable 500 and the power source 166, respectively. Finally, the AHRM circuit board 402 may include at least one fastener opening 506 therein for receipt of a fastener 312 therein for securing the AHRM circuit board 402 to the floor 404 of the housing 300 within the component void 406.

### CONCLUSION

Although systems and methods for autopilot control have been disclosed in terms of specific structural features and acts, it is to be understood that the appended claims are not to be limited to the specific features and acts described. Rather, the specific features and acts are disclosed as exemplary forms of implementing the claimed devices and techniques.

1. An autopilot control system for maneuvering a vehicle based upon attitude information, the autopilot control system comprising:
a pitch gyroscope having a first pitch rate-accuracy and operable to provide a pitch change indication,
a yaw gyroscope having a first yaw rate-accuracy and operable to provide a yaw change indication,
a roll gyroscope having a first roll rate-accuracy and operable to provide a roll change indication;
a processor operable to:
compare the pitch change indication with an AHRM pitch gyroscope having a second pitch rate-accuracy,
compare the yaw change indication with an AHRM yaw gyroscope having a second yaw rate-accuracy,
compare the roll change indication with an AHRM roll gyroscope having a second roll rate-accuracy,
wherein the second pitch rate-accuracy is greater than the first pitch rate-accuracy, the second yaw rate-accuracy is greater than the first yaw rate-accuracy, and the second roll rate-accuracy is greater than the first roll rate-accuracy;
a flight control module operable to instruct maneuvering of the vehicle; and
a housing securing the pitch gyroscope, the yaw gyroscope, the roll gyroscope, the processor, and the flight control module therein.

2. The autopilot control system of claim 1, wherein the processor is operable to:
detect a hard-over condition based upon exceeding a pre-defined threshold in the comparison of the pitch change indication, the comparison of the yaw change indication, or the comparison of the roll change indication.

3. The autopilot control system of claim 2, wherein the processor is operable to detect the hard-over condition while the autopilot control system is engaged and maneuvering the vehicle.

4. The autopilot control system of claim 3, wherein the processor is operable to:
issue an alert of the detected hard-over condition; and
disengage the autopilot control system such that the autopilot control system is no longer maneuvering the vehicle.

5. The autopilot control system of claim 1,
wherein the first pitch rate-accuracy, the first yaw rate-accuracy, and the first roll rate-accuracy are substantially equal, and
wherein the second pitch rate-accuracy, the second yaw rate-accuracy, and the second roll rate-accuracy are substantially equal.

6. The autopilot control system of claim 1, further comprising:
a confirmation-controller circuit board,
wherein the pitch gyroscope is disposed on the confirmation-controller circuit board in a first orientation,
wherein the yaw gyroscope is disposed on the confirmation-controller circuit board in a second orientation,
wherein the roll gyroscope is disposed on the confirmation-controller circuit board in a third orientation,
wherein the processor is disposed on the confirmation-controller circuit board.

7. The autopilot control system of claim 6,
wherein the first orientation of the pitch gyroscope is aligned with an orientation of the AHRM pitch gyroscope,
wherein the second orientation of the yaw gyroscope is aligned with an orientation of the AHRM yaw gyroscope, and
wherein the third orientation of the roll gyroscope is aligned with an orientation of the AHRM roll gyroscope.

8. An autopilot control system for maneuvering a vehicle based upon attitude information, the autopilot control system comprising:
an attitude and heading reference module (“AHRM”) including a set of AHRM gyroscopes operable to provide an AHRM gyroscopic reading;
a gyroscope confirmation module including a set of confirmation gyroscopes operable to provide a confirmation gyroscopic reading;
a processor operable to compare the AHRM gyroscopic reading to the confirmation gyroscopic reading to verify that the set of AHRM gyroscopes is providing attitude information;
a flight control module for maneuvering the vehicle based upon the attitude information; and
a housing containing the AHRM, the gyroscope confirmation module, the processor, and the flight control module therein.

9. The autopilot control system of claim 8, wherein the processor is operable to verify that the AHRM gyroscopes are providing attitude information while the autopilot control system is engaged.

10. The autopilot control system of claim 8, wherein the set of AHRM gyroscopes operates at a first rate-accuracy and the set of confirmation gyroscopes operates at a second rate-accuracy.

11. The autopilot control system of claim 10, wherein the first rate-accuracy is substantially greater than the second rate-accuracy to present a rate-accuracy differential, such that the processor is operable to detect a hard-over condition based on the rate-accuracy differential.

12. The autopilot control system of claim 8, wherein the processor is further operable to:
detect a hard-over condition upon identifying a reading differential between the AHRM gyroscopes and the confirmation gyroscopes being outside a pre-set threshold.

13. The autopilot control system of claim 12,
wherein the autopilot control system is operable to cease operating based upon the detected hard-over condition, and
wherein the autopilot control system is operable to issue an alert of the detected hard-over condition.

14. The autopilot control system of claim 8,
wherein the AHRM is associated with an AHRM circuit board,
wherein the gyroscope confirmation module and the flight control module are each associated with a confirmation-controller circuit board.

15. The autopilot control system of claim 12, wherein the AHRM circuit board is disposed relative to the confirmation-controller circuit board, such that the set of AHRM gyroscopes and the set of confirmation gyroscopes are oriented in a same direction within the housing.

16. The autopilot control system of claim 8, wherein the AHRM further comprises:
a set of accelerometers; and
a set of magnetometers,
wherein the autopilot control system does not include more than three accelerometers and does not include more than three magnetometers.

17. An autopilot control system for maneuvering a vehicle based upon attitude information, the autopilot control system comprising:
an attitude and heading reference module (“AHRM”) including—
an AHRM circuit board;
an AHRM pitch gyroscope disposed on the AHRM circuit board in a first orientation;
an AHRM yaw gyroscope disposed on the AHRM circuit board in a second orientation;
an AHRM roll gyroscope disposed on the AHRM circuit board in a third orientation;
a gyroscope confirmation module including—
a confirmation circuit board;
a pitch confirmation gyroscope disposed on the confirmation circuit board in the first orientation;
a yaw confirmation gyroscope disposed on the confirmation circuit board in the second orientation;
a roll confirmation gyroscope disposed on the confirmation circuit board in the third orientation;
a flight control module for maneuvering the vehicle based upon the attitude information; and
a housing containing the AHRM and the gyroscope confirmation module therein.

18. The autopilot control system of claim 17,
wherein the AHRM pitch gyroscope, the AHRM yaw gyroscope, and the AHRM roll gyroscope each operates at a first rate-accuracy,
wherein the pitch confirmation gyroscope, the yaw confirmation gyroscope, and the roll confirmation gyroscope each operates at a second rate-accuracy, and
wherein the first rate-accuracy is substantially greater than the second rate-accuracy.

19. The autopilot control system of claim 17, further comprising:
an AHRM processor operable to determine a gyroscopic reading for the AHRM; and
a gyroscope confirmation module processor operable to determine a gyroscopic reading for the gyroscope confirmation module.

20. The autopilot control system of claim 19,
wherein the autopilot control system is operable to cease operating based upon identifying a reading differential between the gyroscopic reading of the AHRM and the gyroscopic reading of the gyroscope confirmation module being outside a pre-set threshold,
wherein the autopilot control system is operable to issue an alert that the autopilot has ceased operating.
